(19) United States
(12) Patent Application Publication
(10) Pub. No.: US 2013/0139756 A1
(43) Pub. Date: Jun. 6, 2013

(54) Animal-Operated Grain Dispenser

(71) Applicant: Joseph Lavern Miebach, Albany, OR (US)

(72) Inventor: Joseph Lavern Miebach, Albany, OR (US)

(21) Appl. No.: 13/595,733

(22) Filed: Aug. 27, 2012

Related U.S. Application Data
(60) Provisional application No. 61/531,392, filed on Sep. 6, 2011.

(51) Int. Cl. A01K 15/02; A01K 5/00

(52) U.S. Cl. CPC A01K 15/02; A01K 5/00
USPC 119/51.01

(57) ABSTRACT

An animal-operated grain dispenser capable of dispensing grain, feed, or medicine to an animal interacting with the dispenser is disclosed. The dispenser may serve to entertain as well as feed the animal by way of toys or entertainment devices located within the dispenser. When an animal interacts with the dispenser, a cylindrical housing rotates around a central axis thereby dispensing the grain, feed, or medicine or setting in motion the contained toy or entertainment device. A receptacle optimally positioned beneath the dispenser catches dispensed material

### CROSS-REFERENCES TO RELATED APPLICATIONS

This application claims priority to U.S. Provisional Patent Application Ser. No. 61/531,392 filed on Sep. 6, 2011, entitled “Animal-Operated Grain Dispenser”, the disclosure of which is hereby incorporated by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

The present invention relates to the devices used in the dispensing of animal feed and, more specifically, to devices controlled by the animal.

2. Description of the Related Art

For many thousands of years, farmers and animal enthusiasts have had the need of devices to hold and dispense feed to their animals or livestock. Save for hand-feeding the animals their feed rations, several modalities for serving have been developed. The first method of providing feed for animals was to simply place feed material on the ground, which required the animal to consume not only the feed, but whatever the feed rested upon. This debris includes, but is not limited to, sand, dirt, small rocks, sticks, and other harmful items such as parasites.

Small rocks and sand can prematurely wear the animal's teeth down, shortening the life of the animal by an unacceptable margin. The ingested items can block the intestinal tract and cause colic, a potentially life-threatening condition that often requires surgical intervention to reverse. This is very painful to the animal and enlists a sizable economic contribution to a doctor of veterinary medicine that could otherwise be prevented.

In order to prevent debris ingestion, a trough or similar holding container can be used to hold the feed off of the ground. This is achieved by filling the trough with the entire ration of feed material and having the animal eat at a time of their choosing. Aggressive feeding, sloppy feeding methods cause the animal to push the feed material around inside of the trough eventually spilling it onto the ground surrounding the trough, requiring the animal to once again, consume the debris-filled feed off of the ground, enabling colic or infection.

If the animal chooses to not consume the feed, or the device makes the feed hard to obtain, the feed material is unused and the animal will not receive its full ration of nutrients. This also creates economic waste for the keeper, as more feed is required in order to fulfill the nutritional requirements of the animal.

Another embodiment of the related art blocks the feed from being spilled over the edge of the container, but does not prevent animals from bolt-style feeding in which the animal takes a large bite and pulls their head out of the trough. The engorged mouth of the animal is incapable of consuming the amount of feed and as such, spills the feed onto the ground

Another device requires the animal to keep its head within the feeding apparatus until the food is consumed. This prevents spillage from bolting as long as the animal keeps its head inside of the device. Unfortunately, most animals will not prefer to keep their heads within the feeding chamber, as animals rarely take their eyes and ears off of their surroundings long enough to consume the full ration of feed.

Another presentation of the related art self-regulates the distribution of feed in order to prevent wasteful over consumption and spillage. It accomplishes this by containing a full ration of feed within the gravity-assisted hopper and only dispensing it as quickly as the animal consumes the food. This generally eliminates spillage, but lacks the ability to provide a full ration of food due to the small crevices and relatively small tolerances between the hopper and the receiving feed tray.

None of the related art provides the animal with the ability to self-regulate the dispensation of small manageable bites of feed without wasting feed by way of spillage.

Most existing feed modalities not only lack the ability to deliver full nutritional rations to animal, but also most, if any, lack entertainment value. It is well known, especially in equine communities, that an animal may become intellectually unstimulated if left alone with nothing to provide some form of self-provided stimulation.

A condition known as ‘cribbing’ can cause animals to become destructive out of boredom. Pacing, chewing on their enclosures, and pawing can lead to economically damaging veterinary visits or repairs to property.

Devices as simple as an inflated ball can be used for equine entertainment, but enthusiasm can fall off quickly if there is no reward for playing with said ball. Such devices can also become trapped in tight places such as corners, preventing the animal from continuing interaction, or causing undue injury when trying to dislodge.

In order to encourage continued interaction with the entertainment devices, feed or ‘treats’ can be placed inside of some embodiments and are used as a reward when they are released through a plurality of openings. A problem arises when the non-structurally-bound devices roll across the ground of stalls or arenas and begin collecting dirt, sand, and often, feces. It could be desirable that the device remain bound to a structural component of the enclosure in a predictable and accessible area.

Of the structurally-bound feed-dispensing interactive toys, none offer the ability to fully open the device for cleaning Placing fruit or compostable feeds inside of these devices is common, and as such, will require frequent cleaning Without this cleaning, the animal may be subjected to rotten or moldy feeds, creating a potential health hazard.

In summation, the related arts are suitable for their intended tasks, but there is a need for an improved upon design. By being a structurally bound, non-spillable, feed dispensing entertainment device, the present invention addresses one or more of the above listed shortcomings of the related arts, and possibly others problems that have not been explicitly discussed.

A full understanding of the present invention, including an understanding of the capabilities of the present invention, will be obtained from the following description and accompanying drawings. It should be noted that the following description and accompanying drawings are illustrative only and not intended to limit the present invention to a particular embodiment.

### BRIEF SUMMARY OF THE INVENTION

It is therefore an object of the present invention to provide a grain dispenser that reduces both economic and nutritional loss associated with previous animal dispenser designs.

It is another object of the present invention to provide a dispenser that can be utilized with grain or other pelletized feed.

It is yet another object of the present invention to provide a dispenser that can prevent animal injury or illnesses such as colic, digestive difficulties, or impacting.

It is yet another object of the present invention to provide a dispenser that can be used both indoors and outdoors.

It is yet another object of the present invention to provide a dispenser that dispenses small, manageable bites of feed regulated by the animal.

It is yet another object of the present invention to provide a dispenser that entertains an animal interacting with the dispenser.

In accordance with the objects of the invention described above, one exemplary embodiment of the present invention provides a cylindrical animal-operated grain dispenser that can be mounted to a surface such as a wall found in a stall. The dispenser may have a plurality of holes through with grain may be dispensed when an animal causes the dispenser to rotate or move. The dispenser may also contain an entertainment device such as a toy or noise-making object that can serve as entertainment for the animal even after the grain has been dispensed. The dispenser may also consist of a latchable door through which grain, feed, medicine, or entertainment devices may be delivered into the dispenser.

Other objects and advantages of the present invention will be more fully apparent from the following disclosure.

### BRIEF DESCRIPTION OF THE SEVERAL VIEWS OF THE IMAGE(S)

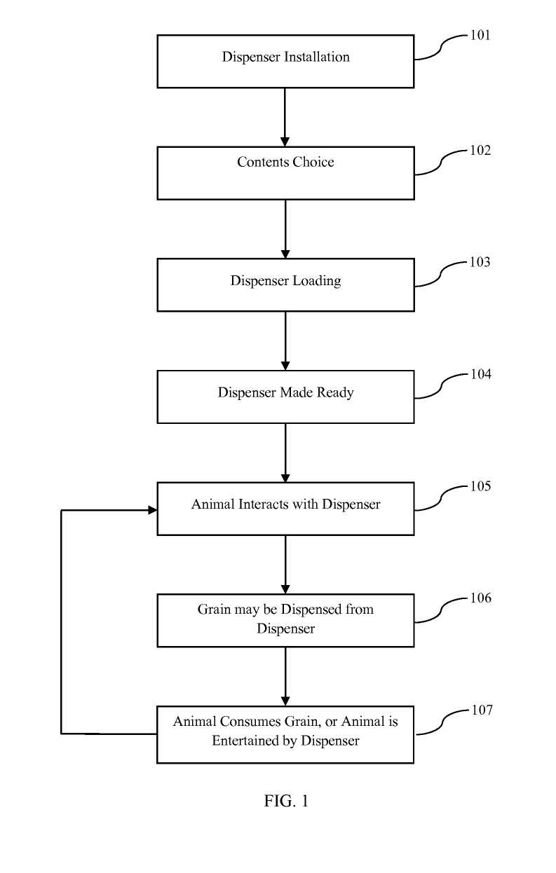

FIG. 1 is a block diagram of an exemplary method for using an animal-operated grain dispenser as according to one embodiment of the present invention;

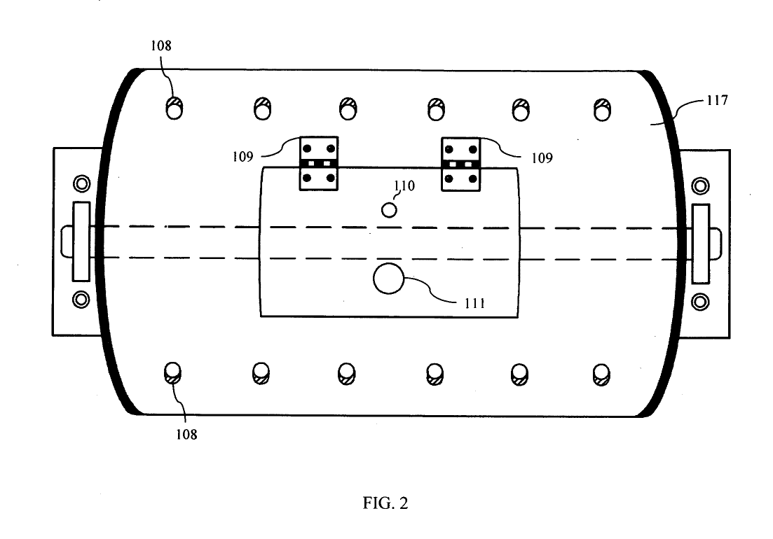

FIG. 2 is an image of an exemplary animal-operated grain dispenser showing a dispenser door and accompanying hardware as according to one embodiment of the present invention;

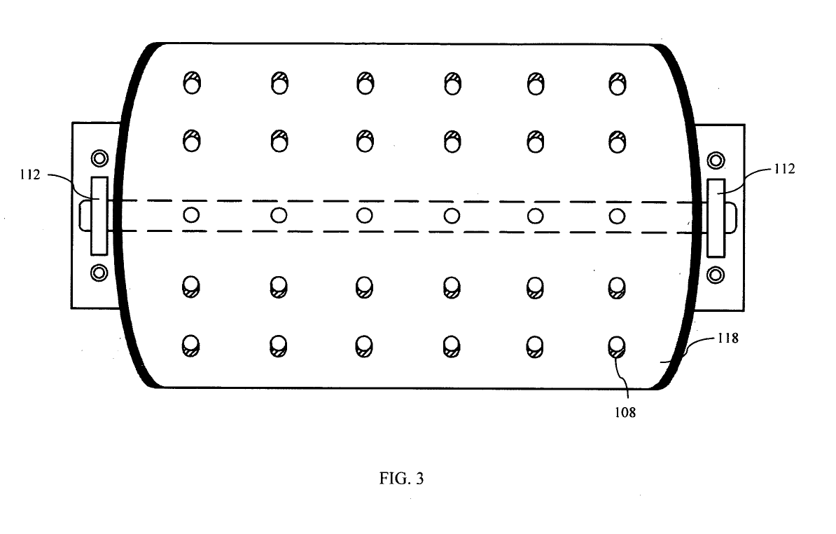

FIG. 3 is an image of an exemplary animal-operated grain dispenser showing a dispenser with mounting brackets as according to one embodiment of the present invention;

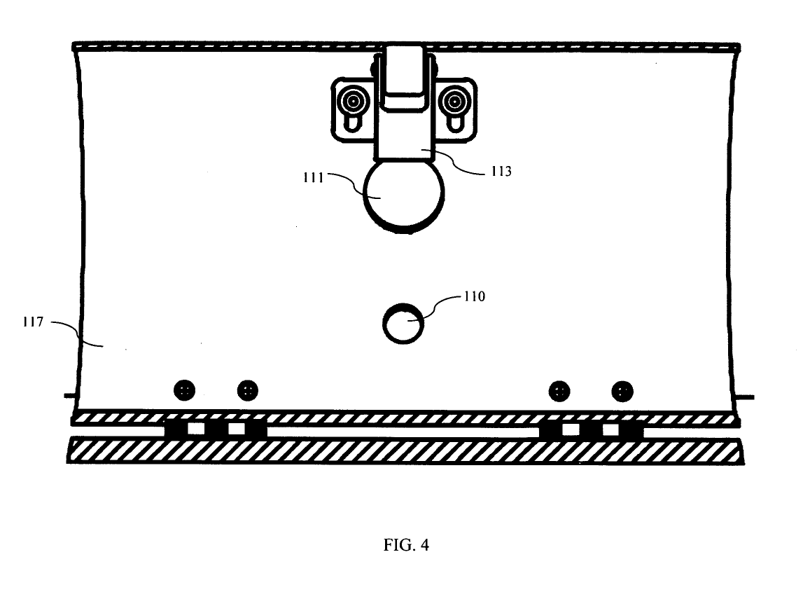

FIG. 4 is an image of an exemplary animal-operated grain dispenser showing a dispenser door latch as according to one embodiment of the present invention;

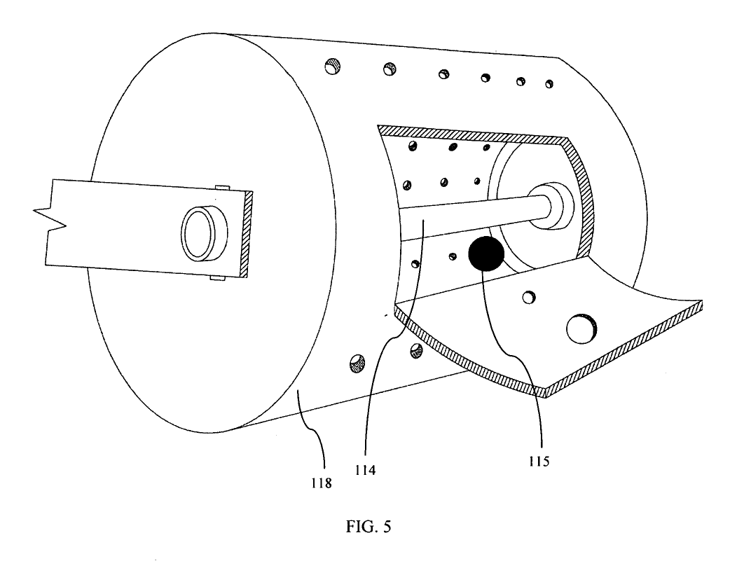

FIG. 5 is an image of an exemplary animal-operated grain dispenser showing the interior of the dispenser with an entertainment device as according to one embodiment of the present invention;

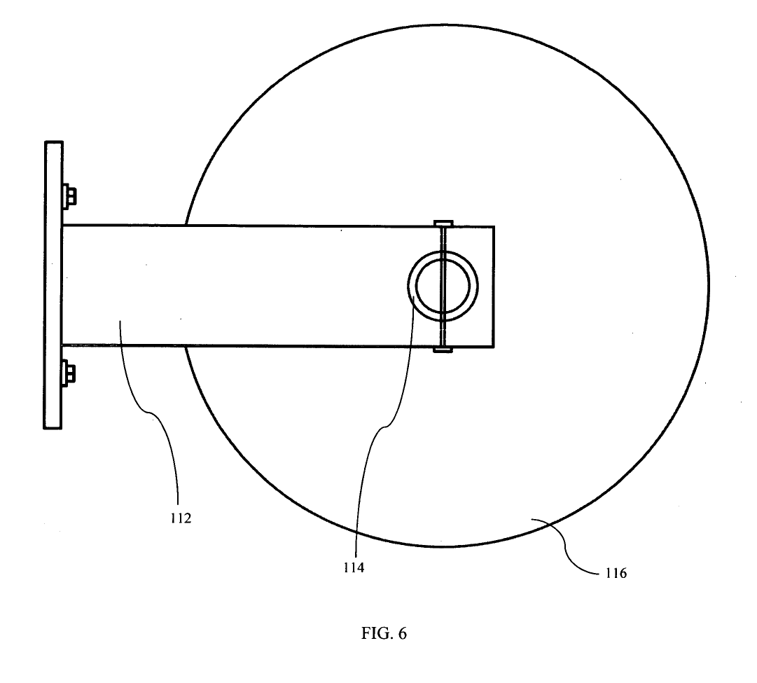

FIG. 6 is an image of an exemplary animal-operated grain dispenser showing a side view of a dispenser and mounting brackets as according to one embodiment of the present invention; and

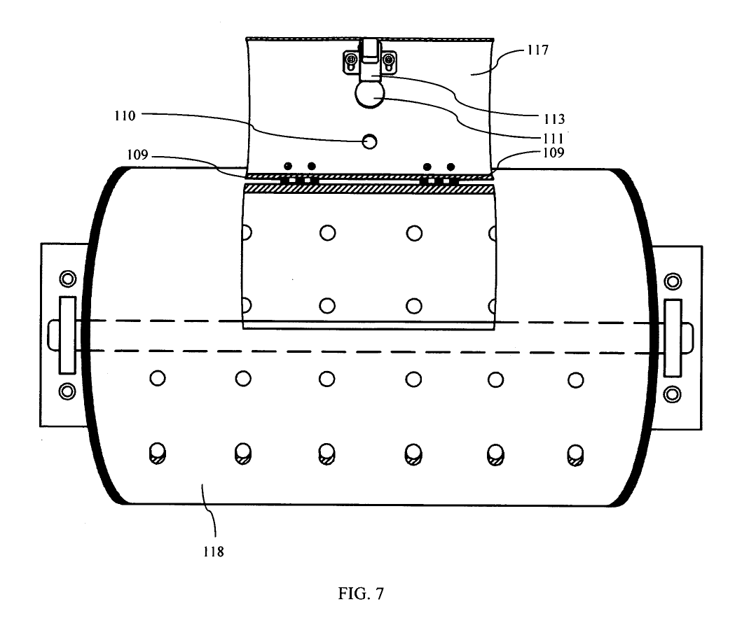

FIG. 7 is an image of an exemplary animal-operated grain dispenser showing an open dispenser door as according to one embodiment of the present invention.

### DETAILED DESCRIPTION OF THE INVENTION

In the following detailed description, reference is made to the accompanying images that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by appended claims, appropriately interpreted, along with the full range of equivalents to which the claims are entitled.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

For the purpose of clarity, all like elements will have the same designations in each of the images. The terms “animal-operated grain dispenser”, “dispenser”, “present invention”, and “invention” may be used interchangeably. In addition to the functions, features, components, and abilities of the apparatus already discussed in this specification, the animal-operated grain dispenser may also have, but not be limited to, the following features contained within the description set forth herein.

Several preferred embodiments of the animal-operated grain dispenser are discussed in this section. However, the invention is not limited to these embodiments. An animal-operated grain dispenser is any device that dispenses grain, food, medicine, or entertains an animal when the animal interacts with the dispenser. The animal-operated grain dispenser is not limited in method of operation, dimensions, attachment means for connecting the animal-operated grain dispenser to a mounting surface, or any other feature appropriate for inclusion as part of an animal-operated grain dispenser.

As set forth in this description and the attached images, an animal-operated grain dispenser has been developed that improves upon conventional animal feeding apparatus. The various embodiments of the improved animal-operated grain dispenser described herein can be used in a wide variety of applications. For example, certain embodiments are particularly well-adapted for use in a horse stall. Other embodiments are particularly well-adapted for use as rabbit feeders. Still other embodiments are particularly well adapted for use in small rodent cages such as cages for hamsters or gerbils. Even other embodiments are particularly well adapted for feeding outdoor livestock including, but not limited to, cows, goats, sheep, or pigs. The preceding exemplary uses are not intended to be limiting, but are merely illustrative for the possible uses of the animal-operated grain dispenser.

A block diagram of an exemplary method for using an animal-operated grain dispenser is illustrated in FIG. 1. The dispenser may first be installed into an animal's enclosure (101). An animal's enclosure may include, but not be limited to a pen, stall, pasture, field, barn, cage, forested area, aquarium, or any other area in which an animal is maintained. Dispenser installation (101) may consist of mounting the dispenser to a wall or other solid surface. The dispenser may also be installed (101) by mounting the dispenser to a structure specifically designed to receive the dispenser, such as scaffolding or other type of supportive structure. After installation (100), a user may choose an appropriate type of grain, feed, or medicine (102) to give to the animal. Many different sizes and types of grain and feed exist which are capable of being used with the dispenser. The user may choose to use a single type of grain, food, medicine, or a combination thereof when loading the dispenser (103). The dispenser may then be made ready for use (104) by closing the dispenser door (117, FIGS. 2, 4, 7). A toy or other entertainment device (115, FIG. 5) may also be placed in the dispenser when it is being made ready for use (104).

Once the dispenser is made ready for use (104), an animal may interact with the dispenser (105) for purposes of entertainment or feeding. An animal interacting with the dispenser (105) for feeding purposes may rotate the dispenser thereby allowing its contents to be dispensed (106) from dispenser openings (108, FIG. 2). Depending on the speed and frequency with which an animal rotates the dispenser, more or less grain may be dispensed (106). An animal could cause the dispenser to rotate rapidly, resulting in more grain, feed or medicine being ejected through the dispenser openings (108, FIG. 2), or could cause the dispenser to rotate slowly, resulting in less grain, feed, or medicine to be ejected through the dispenser openings (108, FIG. 2). An animal may interact with the dispenser (105) by using a nose, paw, hoof, or any other body part capable of causing the dispenser to rotate. A dispenser need not rotate through an entire revolution before grain, feed, or medicine is dispensed (106). An animal could rapidly alternate directions of rotation, essentially shaking the dispenser, or partially rotate the dispenser for grain, feed, or medicine to be dispensed (106). In addition to contents dispensation, an animal may interact with the dispenser (105) for entertainment purposes (107). Animals are often left alone for extended periods of time and the animal-operated dispenser may serve to keep the animal entertained (107). A toy (115, FIG. 5) may be inserted into the dispenser that makes noise or provides tactile feedback when the dispenser is operated.

FIG. 2 shows an animal-operated grain dispenser with a dispenser door (117) that may be of sufficient size and location to permit the introduction of grain, feed, supplements, medications and treats into the cylindrical housing (118). The dispenser door (117) may be mounted to the cylinder housing (118) by dispenser door hinges (109) that could allow the dispenser door (117) to swing outward when opened by a user. A single dispenser door hinge (109) or a plurality of dispenser door hinges (109) may be used to connect the dispenser door (117) to the cylindrical housing (118). The hinges may be constructed out of any material deemed suitable to form the hinges. A user may open the dispenser door (117) by inserting his or her fingers into the small dispenser door finger opening (110) and the large dispenser door finger opening (111) and pulling the dispenser door (117) toward them. Alternatively, the dispenser door hinges (109) may allow the dispenser door (117) to swing into the dispenser when opened. The dispenser door (117) may be constructed of the same material as the cylindrical housing (118), or may be constructed out of any other material deemed suitable to form the dispenser door.

FIG. 2 also shows dispenser openings (108) that may allow for grain to exit the dispenser through animal interaction. The dispenser openings (108) may be of sufficient size and number to permit various sizes and types of grains, medications, and supplements to be dispensed from the dispenser. Some of the types of grain or other feed that may be used with the dispenser include, but are not limited to, cobb grain, beet pulp and rolled corn. Medications and supplements including those that come in pellet, pill, or powder form can be dispensed from the dispenser.

An animal-operated grain dispenser's cylindrical housing (118) with a plurality of dispenser openings (108) is shown in FIG. 3. The cylindrical housing (118) may be constructed of a durable material such as polyvinyl chloride (PVC), wood, metal, plastic or any other material deemed suitable to form the housing of the dispenser. The cylindrical housing (118) may be of sufficient size or shape to contain grain, feed, medicine, toys, noise-making, or other entertainment devices. The cylindrical housing (118) may also be of sufficient size and shape to permit the dispensation of grain, feed and medicine. The cylindrical housing (118) may also be of sufficient size and shape to allow for the toys, noise-making, or entertainment devices (115, FIG. 5) to entertain an animal when it interacts with the dispenser. The cylindrical (118) housing may also be of sufficient size and shape to prevent an animal from biting the housing and causing damage to itself or the dispenser. The cylindrical housing (118) may have one or more transparent or semi-transparent sides (116, FIG. 6) that allow for easy viewing into the interior of the dispenser. The cylindrical housing (118) may have dispenser openings (108) through which grain, medicine, or other feed passes when an animal interacts with the dispenser. The orientation, the direction in which the holes are bored, and pattern of the dispenser openings (108) may be of any configuration desirable for proper dispensation of the grain, medicine, or feed. The size of the dispenser openings (108) may be of any size desirable for proper dispensation of the grain, medicine, or feed. The exact bore size may vary based on the type of feed or grain being dispensed. The cylindrical housing (118) may have a uniform paint scheme, a patterned paint scheme, or may be unpainted. In one preferred embodiment of the present invention, the paint scheme may be a uniform green color. In another preferred embodiment of the present invention, the paint scheme may simulate natural grass. In yet another preferred embodiment of the present invention, the cylindrical housing (118) may be unpainted.

An exemplary dispenser door latch mounted to a dispenser door (117) is shown in FIG. 4. A single dispenser door latch (113) or a plurality of dispenser door latches (113) may be used to secure the dispenser door (117) when the dispenser is in use. According to one preferred embodiment of the present invention, a dispenser door latch (113) may magnetically secure the dispenser door (117) when the dispenser door (117) is in a closed position. In another preferred embodiment of the present invention, a dispenser door latch (113) may mechanically secure the dispenser door (117) when the dispenser door (117) is in a closed position.

The interior of an animal-operated grain dispenser with an axle (114) and an entertainment device (115) is shown in FIG. 5. The axle (114), around which the cylindrical housing (118) may rotate when an animal interacts with the dispenser, may be located along the cylindrical housing's (118) central axis. The axle (114) may extend through the dispenser's sides (116, FIG. 6) so that the axle (114) may be secured to mounting hardware (112, FIGS. 3, 6). The axle (114) may be constructed out of the same material as the cylindrical housing (118), or may be constructed out of any other material deemed suitable to form the axle (114). The entertainment device (115) may serve the purpose of entertaining the animal by making noise or providing tactile feedback when the animal interacts with the dispenser. It is possible for a single or multiple entertainment devices (115) to be inserted into the dispenser. When multiple entertainment devices (115) are used, they may make sound or provide tactile feedback by colliding with components of the dispenser, such as the axle (114) or the cylindrical housing (118), or by colliding with each other.

FIG. 6 shows the side of an animal-operated grain dispenser (116) and mounting hardware (112) that may attach to the axle (114) and to a surface in an animal's enclosure. The dispenser's sides (116) may be transparent or semi-transparent and may allow for easy viewing into the interior of the dispenser. The mounting hardware (112) may allow the dispenser to be detachably attached to a surface such as the interior wall of an animal's stall or pen. The mounting hardware (112) may consist of, but is not limited to, mounting brackets, angle iron, fasteners, or any other hardware suitable for mounting the dispenser to a surface. A single piece of mounting hardware (112) or a plurality of mounting hardware (112) may be used to attach the dispenser to a surface. The mounting hardware (112) may also provide support for the axle (114) and may allow the dispenser to be mounted in any height or position desirable for dispenser functionality. The mounting hardware (112) may be constructed of any material deemed suitable to hold the dispenser in an operable position.

An animal-operate grain dispenser with an open dispenser door (117) is shown in FIG. 7. The dispenser door (117) may be mounted to the cylindrical housing (118) by way of one or more dispenser door hinges (109) and may be held closed by one or more dispenser door latches (113). A user may access the interior of the dispenser by inserting his or her fingers into the large and small dispenser door finger openings (111, 110) and pulling the dispenser door (117) open. Once the dispenser door (117) is open, grain, feed, medicine, toys, noise-making, or entertainment devices (115, FIG. 5) may be inserted into the dispenser. The dispenser door (117) may then be closed thereby making the dispenser ready (104, FIG. 1) for animal interaction.

A receptacle may be used with the dispenser to catch grain, feed, or medicine when an animal interacts with the dispenser. In one preferred embodiment of the present invention, the receptacle may be situated underneath the dispenser and may be elongated in shape to catch grain, feed, or medicine after it is dispensed. It is common for an animal to rotate the dispenser with sufficient velocity to carry any dispensed material significantly far from the dispenser. If the animal were to ingest grain, feed, or medicine directly from a dirt floor, the animal could be at risk for several health problems including colic, digestive difficulties, or impacting. The receptacle may catch the grain, feed, or medicine after dispensation thereby preventing the aforementioned health problems.

The dispenser may be suitable to use with animals that include, but are not limited to, livestock, domesticated animals, pets, wild animals, or any other animal that may use an animal-operated grain dispenser.

Although certain example methods, apparatus and articles of manufacture have been described herein, the scope of coverage of this patent is not limited thereto. On the contrary, this patent covers all methods, apparatus and articles of manufacture fairly falling within the scope of the invention either literally or under the doctrine of equivalents.

With respect to the above description then, it is to be realized that the optimum dimensional relationships for the parts of the animal-operated grain dispenser, to include variations in size, materials, shape, form, function and the manner of operation, assembly and use, are deemed readily apparent and obvious to one skilled in the art, and all equivalent relationships to those illustrated in the images and described in the specification are intended to be encompassed by the animal-operated grain dispenser.

Directional terms such as “front”, “back”, “in”, “out”, “downward”, “upper”, “lower”, “top”, “bottom”, and the like may have been used in the description. These terms are applicable to the embodiments shown and described in conjunction with the images. These terms are merely used for the purpose of description in connection with the images and do not necessarily apply to the position in which the animal-operated grain dispenser may be used.

Therefore, the foregoing is considered as illustrative only of the principles of the animal-operated grain dispenser. Further, since numerous modifications and changes will readily occur to those skilled in the art, it is not desired to limit the animal-operated grain dispenser to the exact construction and operation shown and described, and accordingly, all suitable modifications and equivalents may be resorted to, falling within the scope of the animal-operated grain dispenser. While the above description describes various embodiments of the present invention, it will be clear that the present invention may be otherwise easily adapted to fit any configuration where an animal-operated grain dispenser is desired or required.

As various changes could be made in the above constructions without departing from the scope of the invention, it is intended that all matter contained in the above description or shown in the accompanying images shall be interpreted as illustrative and not in a limiting sense.

What is claimed is:

1. An apparatus comprising:
a cylindrical housing, a dispenser door, mounting hardware and a plurality of dispenser openings wherein the dispenser openings are bored through the cylindrical housing and allow for the dispensation of grain, feed, or medicine when an animal interacts with the apparatus.

1. The apparatus of claim 1, wherein the dispenser door further comprises one or more finger openings.

2. The apparatus of claim 1, wherein the dispenser door further comprises a dispenser door latch.

3. The apparatus of claim 1, wherein the dispenser door is attached to the cylindrical housing by one or more dispenser door hinges.

4. The apparatus of claim 1, wherein an axle supports the cylindrical housing.

5. The apparatus of claim 1, wherein a receptacle is used to catch the dispensed grain, feed, or medicine.

6. The apparatus of claim 1, wherein the cylindrical housing further consists of one or more transparent or semi-transparent sides.

7. The apparatus of claim 4, wherein the mounting hardware attaches to the axle.

8. A method for providing feed, grain, or medicine to an animal comprising:
providing a dispenser comprising a cylindrical housing, a dispenser door, mounting hardware and a plurality of dispenser openings through which the feed, grain, or medicine is dispensed to an animal when the animal causes the dispenser to rotate.

9. The method of claim 8, wherein the mounting hardware allows the dispenser to be attached to a surface.

10. The method of claim 8, wherein the dispenser is capable of containing an entertainment device or toy.

11. The method of claim 8, wherein the cylindrical housing has one or more transparent or semi-transparent sides.

12. The method of claim 8, wherein an axle connects the cylindrical housing to the mounting hardware.

13. The method of claim 8, wherein a receptacle catches dispensed grain, feed, or medicine.

14. A dispenser comprising:
a dispenser door; one or more dispenser openings through which grain, feed, or medicine is dispensed when an animal interacts with the dispenser; and a cylindrical housing that contains the dispenser door and the one or more dispenser openings.

15. The dispenser of claim 14, wherein the dispenser door comprises one or more dispenser door finger openings.

16. The dispenser of claim 14, wherein the dispenser door comprises one or more dispenser door latches.

17. The dispenser of claim 14, wherein the cylindrical housing has one or more transparent or semitransparent sides.

18. The dispenser of claim 14, wherein an axle supports the cylindrical housing.

19. The dispenser of claim 14, wherein a receptacle is used to catch the dispensed grain, feed, or medicine.

20. The dispenser of claim 14, wherein the dispenser is designed to hold an entertainment device.
